(19) United States
(12) Patent Application Publication
(10) Pub. No.: US 2002/0078371 A1
(43) Pub. Date: Jun. 20, 2002

(54) User Access system using proxies for accessing a network

(75) Inventors: Joerg Heilig, Hamburg (DE); Matthias Huetsch, Hamburg (DE)

Correspondence Address: SUN MICROSYSTEMS INC, 901 SAN ANTONIO RD, MS PALO1-521, PALO ALTO, CA, 94303, US

(73) Assignee: Sun Microsystems, Inc.

(21) Appl. No.: 09/930,873

(22) Filed: Aug. 15, 2001

Related U.S. Application Data
(60) Provisional application No. 60/279,552, filed on Mar. 28, 2001.

(30) Foreign Application Priority Data
Aug. 17, 2000 (EP) 00 117 721.1

(51) Int. Cl. H04L 9/00

(52) U.S. Cl. 713/200

(57) ABSTRACT

Apparatus and methods of using proxies for accessing a computer network, e.g. through a publicly accessible network, is disclosed. A connection between the client and a network server is established not directly but through a client proxy device located at the client and a proxy server at the local area network. The connection between the client proxy device at the client and a proxy server at the local area network may be established through a firewall restricting access to the local area network and/or client. In establishing the connection, ports of the client proxy device at the client side may be mapped in multiple operations to the ports of network servers of the local area network. The invention allows the client to utilize common network protocols such as for example ftp, http, IMAP and similar at the client side to access data or services available at the local area network side.

### CROSS-REFERENCE TO RELATED APPLICATIONS

The following-identified U.S. and foreign patent applications are relied upon and are incorporated by reference in this application.

European Application No. 00 117 721.1 entitled USER ACCESS SYSTEM USING PROXIES FOR ACCESSING A NETWORK, filed on Aug. 17, 2000; and U.S. Provisional Patent Application No. 60/279,552, entitled USER ACCESS SYSTEM USING PROXIES FOR ACCESSING A NETWORK, filed on Mar. 28, 2001.

### BACKGROUND OF THE INVENTION

1. Field of the Invention

The present invention relates to an access system and a method for enabling a user to access a local area network, e.g. using a public network.

2. Description of Related Art

Today's public and private communication networks are increasingly used for applications involving data transmissions over networks of data processing devices. For example, growing numbers of financial transactions or access sessions to review, retrieve or manipulate data are executed over public networks and it is of high importance to prevent access to personal data by unauthorized parties and to provide a secure data transmission link for executing these transactions. However, at the same time it is desirable that an authorized user may conveniently access the service.

If a secure transmission line between a client and a local area network is available, convenient user access is established relatively easily. However, in case a local area network is accessible from a remote host, for example via a public network like the Internet, avoiding unauthorized access from the public network to the local area network generally requires complex security measures. These measures may make it difficult for a user to obtain convenient access to services available at the local area network.

### SUMMARY OF THE INVENTION

It is therefore desirable to provide an access system and corresponding method for enabling improved access from a client to a local area network.

An access system for enabling a user to access a local area network may comprise a client proxy device adapted to exchange data with a client processing device and with at least one network server of the local area network through a proxy server. Further, the access system may comprise a client proxy network connect module coupled to the client proxy device and a proxy server network interface coupled to the proxy server. The client proxy network connect module and proxy server network interface may utilize communication protocols known in the art to establish a data transmission link between the client proxy device and the proxy server, in order to establish communications between the client proxy device and the proxy server.

According to embodiments of the invention, processes executing on the client data processing device may not directly access a one of the at least one network servers connected to a local area network, but instead transmits a data request to a client proxy device for further execution. The client proxy network connect module and proxy server network interface may select a network server for serving or processing the data request, and further, a communication link between the client proxy device and the network server may be established via the data transmission link. Once a communication link is established, the network server may serve the data request from the client data processing device.

Further, the network server may be selected based on a port at the client proxy device receiving the request and/or by information included into the request. Furthermore, the communication link between the client proxy device and the network server may include a port of the client proxy device and a port of the network server.

In one embodiment of the invention, the client proxy network connect module may be arranged to generate a list of assignments between at least one port of the client proxy device and at least one port of the at least one network server. The client proxy network connect module may be arranged for retrieving corresponding mapping rules, at least including information on establishing the data transmission link between the client proxy device and the proxy server. The mapping rules may further include address information of the at least one network server of the local area network.

In an embodiment of the invention, the client proxy network connect module may comprise a first sub-connection module for mapping at least one port of the proxy server to at least one port of the client proxy device. Alternatively, the proxy server network interface may comprise a second sub-connection module for mapping at least one port of the at least one network server to at least one port of the proxy server, wherein the mapping is in accordance with the retrieved mapping rules.

The data transmission link between the proxy server and the client proxy device may involve a secure communication via a public network. An authorization procedure for authorizing access to the proxy server may be executed at the client data processing device, e.g. by a user at the client data processing device. The data transmission session with the client proxy device may be established through a firewall restricting access to the local area network from the outside.

In one embodiment of the invention, the client proxy network connect module may comprise mapping rules designating a port of the client proxy device to a port of the firewall. The proxy server network interface may also comprise mapping rules designating a port of the firewall in conjunction with a port of the proxy server.

In another embodiment of the invention, the client data processing device may be part of a client network and the data transmission link between the client proxy device and the proxy server is further established through a firewall restricting access to the client network from the outside.

The proxy server may be located inside a firewall restricting access to the local area network from the outside and may be configured to allow access only to selected network servers.

In one embodiment of the invention, the client proxy device may be registered as a proxy at the client data processing device for executing an application that is proxy enabled, i.e. that allows registering a proxy. Further, at the client data processing device the name of a network server may be replaced by the name of the client proxy device and a specific port for an application that is not proxy enabled.

In another embodiment of the invention, an access method for enabling a user to access a local area network may include receiving a request at a proxy server from a process executing at a client data processing device. The method of the embodiment further includes establishing a data transmission link between the client proxy device and a proxy server and determining one of the at least one network servers based on the request. The method of the embodiment further includes establishing a communication link between the client proxy device and the network server involving the data transmission link, and authorizing the network server to serve the request.

Particular and preferred aspects of the invention are set out in the accompanying independent and dependent claims. Combinations of features from the dependent claims may be combined with features of the independent claims as appropriate and not merely as explicitly set out in the claims.

### BRIEF DESCRIPTION OF THE DRAWINGS

Exemplary embodiments of the present invention will be described hereinafter, by way of example only, with reference to the accompanying drawings in which like reference signs relate to like elements and in which:

FIG. 1 is a high level diagram of a computer network system that includes a user access system on a client device used in an embodiment of the invention;

FIG. 2 shows a process flow diagram of a method of processing a data request from a client used in one embodiment of the invention;

FIG. 3 shows a block diagram illustrating elements of the system for enabling access to a local area network used in another embodiment of the invention;

FIG. 4 shows a process flow diagram of a method of processing a data request from a client used in one embodiment of the invention;

FIG. 5 shows a flow diagram of a time sequence of transmissions according to another embodiment of the invention;

FIG. 6 shows a flow diagram of a time sequence of transmissions according to another embodiment of the invention;

FIG. 7 shows a block diagram illustrating elements of a system for enabling access to a local area network according to a further embodiment of the invention;

FIG. 8A shows a block diagram illustrating elements of a system for enabling access to a local area network according to an embodiment of the invention involving access through a firewall;

FIG. 8B shows a block diagram illustrating elements of a system for enabling access to a local area network according to a further embodiment of the invention enabling access through a firewall;

FIG. 9 shows a block diagram illustrating elements of the system for enabling access to a local area network according to an embodiment of the invention involving access through a firewall;

FIG. 10 shows a block diagram illustrating elements of the system for enabling access to a local area network according to an embodiment of the invention including a client side network; and

FIG. 11 shows a flow diagram of a time sequence of transmissions according to another embodiment of the invention.

In the Figures and the following Detailed Description, elements with the same reference numeral are the same element or similar elements.

### DETAILED DESCRIPTION

Exemplary embodiments of the present invention are described in the following with reference to the accompanying drawings.

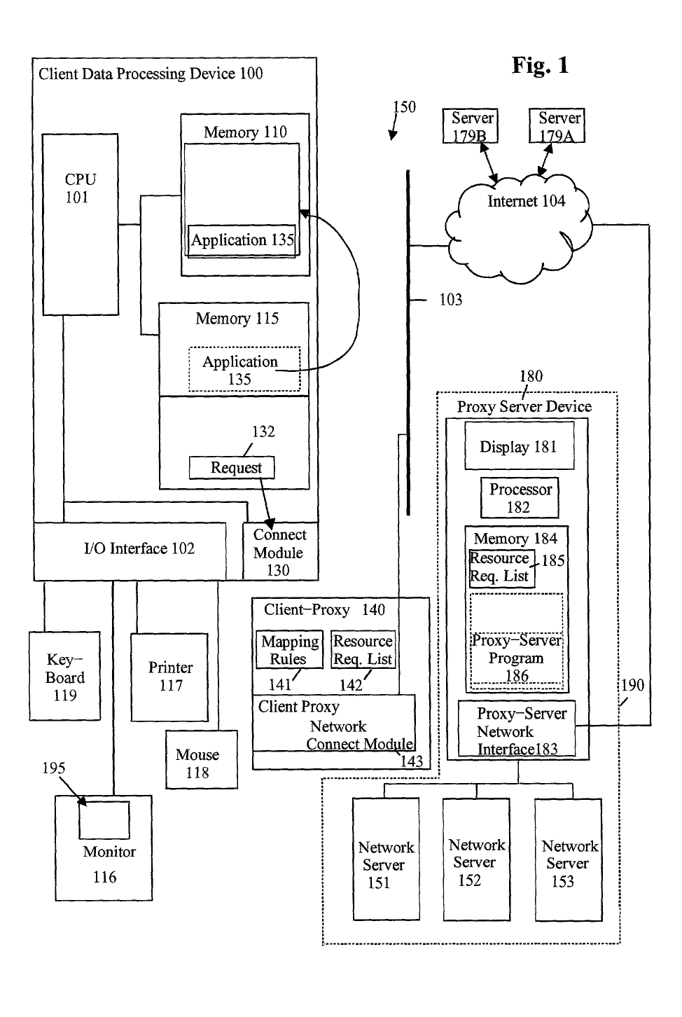

According to one embodiment of the present invention, as shown in FIG. 1, a user can access the user's data or other data of interest to an available to the user from a client data processing device 100. When a first computer program executing on a user device, e.g. device 100, issues a request for data in response to a user input, the request is received by a second computer program, e.g., proxy server device 180, executing on another computer system, e.g. server system 180.

Proxy server device 180, upon receipt of the request, will select any one of a plurality of network servers 151 through 153 to handle the data request, and will establish a communication link between user device 100 and the selected network server, e.g. server 151.

FIG. 1 further illustrates elements of an access system including a client proxy device 140 for exchanging data with a client data processing device 100 via a connect module 130. Further, FIG. 1 shows client proxy network connect module 143 for connecting the client proxy device 140 and a proxy server device 180 via a network interface 183. Still further, FIG. 1 shows as three exemplary network servers 151, 152, and 153 connected to the proxy server device 180, e.g. via a communication network such as a local area network 190.

A user operating the client data processing device 100 to send a request to proxy server device 180 shown in FIG. 1 thus receives improved access to information on the network servers 151, 152, and 153 through the client proxy device 140 and the proxy server device 180. This allows the user at client data processing device 100 improved for requesting services from the network servers such as obtaining data files, starting applications, and similar.

In the embodiment illustrated in FIG. 1, the client data processing device 100 does not directly access a desired one of the network servers 151-153. Instead, the client proxy device 140 executes the request on behalf of the client data processing device 100. Upon detecting a request from the client data processing device 100, connect module 130 will transmit the request to client proxy device 140, which may, in conjunction with proxy server device 180, select any one of the plurality of network servers 151-153 to handle the request. Connect module 130 then works to establish a communication link between client proxy device 140 and proxy server device 180.

This may be particularly advantageous in case a direct communication between the client data processing device 100 and the network servers 151-153 is not possible, e.g. due to security restrictions, e.g. a firewall, or other access restriction limiting access to network servers 151-153 connected in a local area network 190.

In the following the elements of the access system of FIG. 1 will be described in further detail.

The client data processing device 100 may be a general purpose data processing device, or a mobile terminal, such as a mobile phone, a mobile data organizer, or similar. The client data processing device 100 is preferably equipped with connect module 130, which may include a internal connection such as a communications bus or an external connection such as a modem, network interface connection, or similar device to communicate with other data processing devices. Connect module 130 may be a dedicated data processing device connectable to the client proxy device 140 or may comprise a code section stored at first memory 110 or second memory 115 and executable at a data processing device such as client data processing device 100. Connect module 130 may communicate with client proxy device 140 through a communication link such as a dedicated line, via a network or similar, including wireless transmission and internal connections, e.g. an internal connection in a data processing device. This connection may be a temporary connection, established on demand upon generation of a request at the client data processing device 100, and may be maintained for further requests. Requests may for example relate to a retrieval of data from the network servers, relate to execution of an application at the network servers, or similar.

The client proxy device 140 may comprise a dedicated data processing device, or may be realized by a code section executed for example at the client data processing device 100. The client proxy device 140 may be located at an arbitrary location; however, it may be preferred to locate the client proxy device 140 in close proximity to the client data processing device 100, e.g. to ensure short communication paths which may be more easily protected from unauthorized listening.

The client proxy device 140 preferably acts on behalf of the client data processing device 100 in executing at least some of the requests generated at the client data processing device 100, i.e. the client proxy device 140 may act as a proxy for the client data processing device 100.

In general, a proxy is an entity that is authorized to act on behalf of another entity, i.e., to execute operations such as communication requests on behalf of the requesting entity. As is common in network applications, a proxy receives, e.g. a request for data from a requesting device and retrieves the data on behalf of the requesting device. Since in network applications usually the destination address as well as the originating address is specified, the proxy preferably includes his own address as originating address. Therefore, any requested data will be transmitted back to the proxy. After receiving the requested data the proxy transmits the requested data to the requesting entity, e.g., a data processing device of a user who wishes to access information on a public network such as the Internet.

In the present case, the client proxy device 140 may be registered as a proxy at the client data processing device 100 to handle at least some of the requests generated at the client data processing device 100. Alternatively, the client data processing device 100 may otherwise be configured to transmit at least some requests to the client proxy device 140.

For example, application 135, which may comprise executable computer program instructions that may be stored in first memory 110 or second memory 115, may make a request 132 to access data or other information available on local area network 190. For example, application 135 may comprise a network browser program that may display information retrieved from local area network 190 on browser window 195 displayable on monitor 116. Application 135 may direct connect module 130 to communicate with client proxy device 140 when a request to access local area network 190 is made. The client proxy device 140, after receiving the request 132 from client data processing device 100, retrieves the requested data as described below and then transmits the requested data to client data processing device 100.

Alternatively, when requests to access devices outside local area network 190 are made, application 135 may instruct connect module 130 to communicate directly via the Internet 104 with network servers 179A-179B.

Client proxy network connect module 143 is responsible for establishing the required connection between the client proxy device 140 and the appropriate network server. The client proxy network connect module 143 may comprise a dedicated data processing device connectable to the client proxy device 140. Alternatively, client proxy network connect module may comprise a code section executed at a data processing device such as client data processing device 100, client proxy device 140, or similar.

In particular, upon reception of a request from the client data processing device 100 at the client proxy device 140, the client proxy network connect module 143 may select at least one of the network servers 151-153 of local area network 190 to serve the request. The request may comprise, for example an HTTP request for information displayable on browser window 195, an FTP request for file data, or a request to retrieve email messages using the IMAP or similar protocol. The selection of a network server may occur via any of a variety of processes. For example, the selection may be based on information, such as file size or type, included into the request, an identifier transmitted in association with the request, and/or a particular service or service type requested in connection with the request. For facilitating a selection, the client proxy network connect module 143 may access information stored at client proxy module 140, such as mapping rules 141 or request list 142, which may include information on services available at the network servers and/or address information of the network servers.

The selected network server may also be responsible for further routing the request, i.e. act as a gateway or proxy for further distributing the request to further network servers. For example, in the particular case where a plurality of network servers is available for serving a particular type of request, the selected network server may act as a gateway or proxy for further distributing the request.

Preferably, client proxy network connect module 143 and proxy server network interface 183 also establishes a data transmission link between the client proxy device 140 and the proxy server device 180, e.g. via a network such as the Internet and/or via a dedicated communication line including wireless transmissions. The data transmission link may be referred to as a tunnel, as it may pass or tunnel elements restricting access to the local area network 190, such as firewalls or the like. This data transmission link may be used to establish a secure connection through a publicly accessible network, as outlined with respect to further embodiments. Establishing such a data transmission link may involve contacting the proxy server device 180 and the client proxy device 140 and negotiating a communication protocol between these two devices, for example involving a particular method of exchanging data and/or security measures. The data transmission link may be established on demand, e.g. upon request from the client proxy device 140, in case the client proxy device 140 receives a request for data from the client data processing 100. Alternatively, the data transmission link may be established once at system set-up and then may be maintained throughout operation time. The data transmission link may accommodate a plurality of communication links between the client data processing device 100 and the at least one network server 151-153 via proxy server device 180.

Still further, client proxy network connect module 143 and proxy server network interface 183 preferably establish a connection between the client proxy device 140 and the selected network server involving a data transmission link. This preferably includes instructing the proxy server to connect to the selected network server. Thus, the communication link will use a transmission path from the client proxy device 140 through the proxy server device 180 to the selected network server. The partition of the communication link between the client proxy device 140 and the proxy server device 180 will thus use the transmission link as described above as transmission medium or carrier. The partition of the communication link from the proxy server device 180 to the selected network server may be a connection as common in network applications involving packet switched communication or any other connection. The connection may be established on demand through the client proxy device 140 upon reception of a request. The transmission link may be maintained for further connections involving the same client, the same network server, and may be limited to the same type of request.

As discussed above, the client proxy network connect module 143 and the proxy server network interface 183 may each be realized as a dedicated data processing device. Alternatively, module 143 and interface 183 may comprise code sections executed, e.g. at the client proxy device 140 or the client data processing device 100 for the client proxy network connect module 143, or at the proxy server device 180 for the proxy server network interface 183. In addition, any combination of these potential embodiments may be utilized.

The proxy server device 180 may comprise a data processing device having a large capacity for serving a large number of client requests. The proxy server device 180 may act as a proxy, i.e., executes requests on behalf of another entity, in the present case for example upon request of the client proxy device 140. The proxy server device 180 is connectable to the network servers 151, 152,and 153 in local area network 190. The connections may be temporary connections, established, e.g. on demand upon generation of a request at the client data processing device 100, but may also be maintained for further requests.

The network servers 151-153 may for example, each comprise a data processing device having a large capacity for serving a large number of client requests and/or for storing large amounts of data. Even though only three network servers are shown in FIG. 1, it is understood that an arbitrary number of network servers may be provided inside and outside local area network 190. The proxy server device 180 and the network servers 151, 152,and 153 are shown to be connected via the local area network 190. It is also possible that the proxy server and the network servers are connected via dedicated communication lines or via a wide area network such as the Internet or a combination of networks. Finally, it is possible that some of the network servers are part of the local area network 190, while other network servers are part of other networks while being accessible through the proxy server device 180.

The access system of the embodiments of the invention set forth above provide improved access for, e.g., a user operating the client data processing device 100 to access information on the network servers 151, 152, and 153, even if direct access to network servers is not possible due to access restrictions at the local area network. Access may be obtained from the client data processing device 100 through the client proxy device 140 and the proxy server device 180, e.g. for requesting services from the network servers such as obtaining data files, starting applications, and similar.

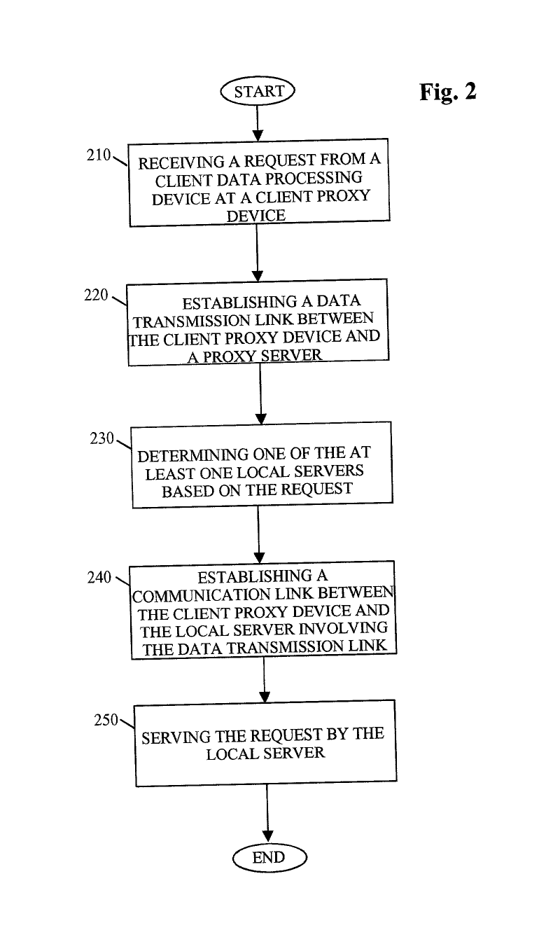

In the following a further embodiment of the invention will be described with respect to FIG. 2. FIG. 2 shows a flow diagram of a sequence of operations of the method according to another embodiment of the invention.

As in the previous embodiment, the operations outlined with respect to this embodiment allow improved access to a local area network from a client data processing device. Access is facilitated by employing a network connect module in a client proxy device 140 in conjunction with a proxy server network interface in a proxy server device 180.

In a first operation 210 a request from a client data processing device 100 is received at the client proxy device 140. The request may for example be a request for data, or a request for a particular service, such as the execution of an application program or similar. As an example, a user operating the client data processing device 100 could generate a request concerning the display of a particular document at the client data processing device 100. This request could be for example generated by entering a particular network address specifying a storage location of the requested document at the client data processing device 100. Alternatively, the request may be generated by clicking onto a correspondingly marked area or a display, e.g. display window 195, associated with the client data processing device 100 or could be generated by clicking onto an icon on a display associated with the client data processing device 100. The request may contain information on a requested document and/or service and may contain information on the client data processing device 100 originating the request and similar.

In an operation 220 for example the network connect module 143 of the client proxy device 140 and the proxy server network interface 183 of the proxy server device 180 establishes a data transmission link or “tunnel” between the client proxy device 140 and proxy server device 180. This may involve sending a transmission request to the proxy server device 180, negotiating communication protocols, such as TCP/IP, as known in the art, establishing and utilizing encryption methods, and similar issues.

In an operation 230 the client proxy device 140 or the proxy server device 180 may determine one of the at least one network servers based on the request from the client data processing device 100. For example, information on the desired network server may be included into the request and/or the desired network server may be determined based on an identifier transmitted in association with the message. Alternatively, information on the desired network server may be determined based on a type of request received at the client proxy device 140 and the proxy server device 180. For example, in case the request from the client data processing device 100 include e-mail services, the client proxy device 140 and/or the proxy server device 180 may determine a network server providing email services. In case the request from the client data processing device 100 includes a request for an HTML (Hypertext Markup Language) document, the client proxy device 140 and/or the proxy server device 180 may determine a network server providing HTTP services. As is common in network applications, the selected network server may also be a gateway or proxy for further distributing the request.

The determination or selection of a network server for providing the requested services may be made through a resource request list 142 on client proxy device 140 or a similar resource request list 185 on proxy server device 180. The resource request list 142 on the client proxy device 140 and resource request list 185 on proxy server device 180 may maintain information on the available network servers and service provided by the network servers.

After an appropriate one of the network servers is determined based on the request, in an operation 240 a communication link between the client proxy device 140 and the network server may be established via the data transmission link previously established between the client proxy network connect module 143 and the proxy server network interface 183. The communication link may be a communication link as is common in network applications involving packet switched transmissions and may therefore be a point to point bi-directional connection. The communication link between the client proxy device 140 and the network server 180 may be established for serving a single request only or may be maintained after serving the initial request for further requests, e.g. with similar contents.

Thereafter, in an operation 250 the request is served by the network server 151-153. Service may include retrieving data from the network server through the proxy server device 180 based on the request and transmitting the data through the proxy server based on the request and transmitting the data to the client data processing device 100. Alternatively, the service may include executing an application at the network server under control of the client data processing device 100. This may involve bi-directional communications between the network server and the client data processing device 100 via a communications link, as described above. These bi-directional communications may involve, for example, interactively controlling the execution of an application at the network server via the client data processing device 100, e.g. for scrolling through a document, or for editing purposes, or for displaying parts of image data such as a bitmap. The request may be served in any of a variety of protocols known in the art, including bitmap protocols or the X Windows protocol.

In addition, serving the request may include further distribution of the request to additional network servers outside of the initial network server.

It is also noted that the sequence of operations outlined above may be altered, in particular, operation 220 may generally be executed at any time, for example before operation 210 or after operation 230.

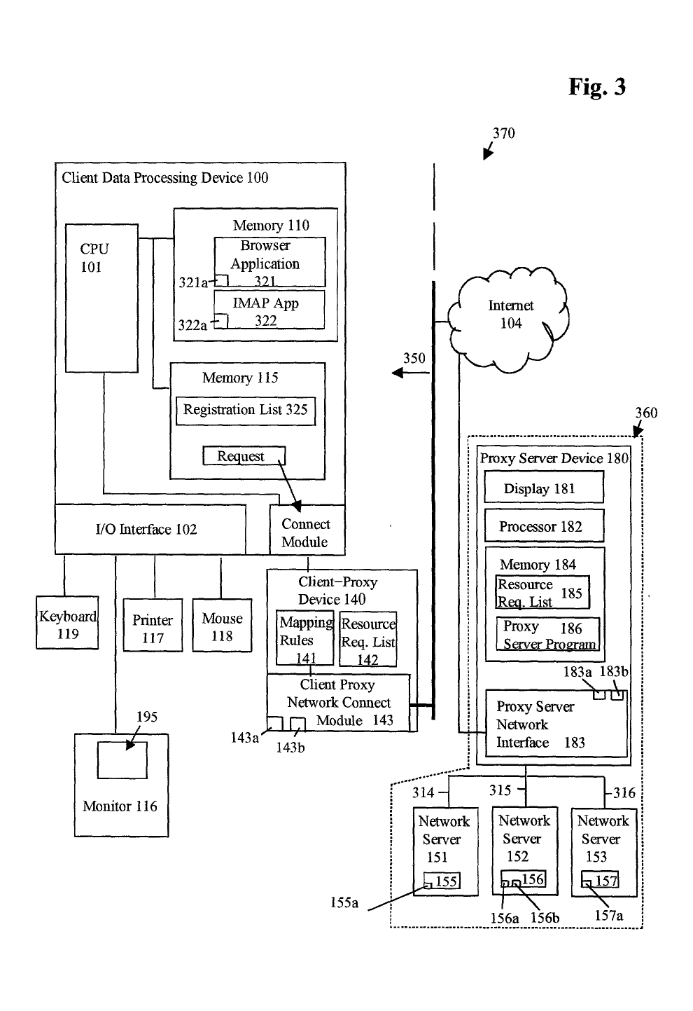

In the following, a further embodiment of the invention will be described with respect to FIG. 3. FIG. 3 shows a block diagram of an access system for enabling access to a local area network according to another embodiment of the invention.

Further to the elements of FIG. 1, FIG. 3 shows a browser 321 and an IMAP (Internet Message Access Protocol) application 322 running at the client data processing device 100. The client data processing device 100, the client proxy device 140, and the client proxy network connect module 143 are arranged at a client side 350, e.g. a user located at a client computer and wishing to access services provided by embodiments of the invention.

In the present embodiment the client data processing device 100, again does not directly access a desired one of the network servers. Instead, the client proxy device 140 and the client proxy network connect module 143 execute the request on behalf of the client data processing device 100 by determining one of the at least one network servers based on the request. This may be accomplished by establishing a data transmission link between the client proxy device and the proxy server device 180 that may be included when establishing a communication link between the client proxy device and the network server.

The browser 321 may be connectable via a connection module 321a to a port 143a of the client proxy network connect module 143, and the IMAP or email application 322 is connectable via a connection module 322a to a port 143b of the client proxy network connect module 143. Data received from the browser 321 and the IMAP application 322 is transmitted from the client proxy network connect module 143 through the network to the proxy server network interface 183. The data is then transmitted from proxy server network interface 183 to network servers 151, 152, and 153 which may receive the data from the proxy server via connections 314, 315, and 316. The data may be received at the network servers via network interface 155, 156, and 157, which have opened ports 155a, 156a, and 157a respectively upon establishment of a connection with client proxy device 140. The ports may, e.g. receive packets of data. Furthermore, the connections established may be temporary connections, established on demand upon generation of a request, but may be maintained operable for further requests. Further, all connections established preferably allow bi-directional communication, i.e. data can be transmitted in both directions via a connection once it is established.

The elements at the client side 350 and the local area network 360 are shown as part of a wide area network 370, such as a public network, for example the Internet or any other network.

The client data processing device 100 may run application programs generating requests for data or messages, for example the browser 321 for browsing information or transmitting data in data communication networks. Generally, a browser may comprise a software program or code section that, upon execution at a client computer, allows a user to browse through a set of data. Browser software may also serve as a front end to a network such as the World Wide Web on the Internet. In this case, a user may enter an address of a web site into a browser's location field and a corresponding home page will be downloaded for local display. Further, the user may enter the address and name of a particular document, in which case the document will be downloaded for display. The downloaded information may, if visualized, serve as an index to other pages on the web site which can be accessed by clicking on for example a “click here” message, highlighted hyperlink text or an icon on the screen.

Further, the client data processing device 100 may run an application program as for example the IMAP application 322, e.g. a mail processing application for sending, receiving, and handling of email documents remotely on one of the network servers.

Further application requiring access to the network servers may be provided, such as applications for remotely controlling the execution of application programs at a local server.

In the present case the client proxy device 140 handles requests generated at the client data processing device 100. Thus, requests, e.g. generated by the browser 321 will be sent to the client proxy device 140 for execution. It is possible that all requests generated at the client data processing device 100 are transmitted to the client proxy device 140 for further handling. However, it is also possible that only selected requests are sent to the client proxy device 140, e.g. requests of a particular type or generated by a particular application at the client data processing device 100. In this case, requests which are not transmitted to the client proxy device 140 may be directly executed at the client data processing device 100, i.e. these requests may be directly transmitted over a network such as the Internet, as is well known in the art.

The client data processing device 100 and the client proxy device 140 in FIG. 3 are illustrated as separate entities and it is to be assured that requests are transmitted from the client data processing device to the client proxy device. Therefore, at the client side 350, a registration list may be provided, wherein the client proxy device 140 is registered as a proxy at the client data processing device 100. Thus, in case the client data processing device 100 executes an application, e.g. browser 321 and/or IMAP application 322, that is proxy-enabled, requests generated by these applications are sent to the client proxy device 140. Registering the client proxy device as a proxy may be accomplished for example by entering a network address of the client proxy device 140 at the client data processing device 100. For example, applications that are proxy-enabled may provide an option to register another device as a proxy by entering a network address into a specified location on a display. A client at a proxy-enabled browser may thus be able to enter an IP-address and a port number for a specific service, i.e. communication type requested. Entering the IP-address and the corresponding port number at the client, e.g. at the client browser or email processing system, ensures that all requests from the respective applications at client data processing device 100 are transmitted to the corresponding port at the client proxy device 140. For example, in the case of an HTTP request, e.g from browser program 321 of the client data processing device 100, the request will be transmitted through port 321a of the processing device. Also, any IMAP request from IMAP application 322 will therefore preferably be sent through port 322a of the processing device 100. In both cases, the request will then be transmitted to client proxy device 140 and be transmitted to proxy server device 180 via ports 143a and 143b.

In case an application is not proxy-enabled, the application is not able to utilize a proxy registration list 325. Therefore, in the case where an application that is not proxy enabled is executed at the client data processing device, e.g. a non proxy-enabled browser and/or a non proxy-enabled IMAP application, the name of a network server is replaced by the name of the client proxy device 140 and the appropriate port. This may be accomplished by a software program run at the client data processing device and will ensure that requests of an application to the network servers 151, 152, and 153, will only be sent to the client proxy device 140.

The client data processing device 100, executing the browser 321 and the mail processing application 322 are connected to the client proxy device 140 via a standard packet-switched network connection or any other connection for exchanging data. In case of packet-switched connections, as shown in FIG. 1, the connection will have a starting point at the client data processing device 100 and an ending point or port at the client proxy device 140. In FIG. 3, the communication path from the browser program 321 goes through port 321a on the browser to a port 143a at the client proxy device 140. A communication path from IMAP application 322 goes through port 322a on the IMAP application program to a port 143b on the client proxy device 140.

As is common in networks, e.g. in packet oriented networks, each connection is characterized by an origin and a communication end point. Each communication end point is comprised of a port having a predetermined number and a receiver address, i.e. the address of a particular machine. For each communication type a specific port is provided. Common port numbers for standard communication types are port number 80 for HTTP (HyperText Transfer Protocol), port number 21 for FTP (File Transfer Protocol), and port number 143 for IMAP (Internet Message Access Protocol).

Data packets are routed from the originating entity to a communication end point. Therefore, a packet can be routed to a destination using the IP (Internet Protocol) address of the destination device and an appropriate port number. For example, a selected hyperlink, e.g. selected by clicking on it using a standard browser will be translated into an IP-address and a port number using a Domain Name System (DNS). If for example a browser connectable to a network such as the Internet attempts to retrieve an HTML document from the Internet, the device storing and serving the requested data will be addressed using its IP address, and further, the HTTP port, i.e. port number 80, will be specified.

In the embodiment discussed above, it is assumed that port 143a is configured to receive HTTP requests from the browser 321,and the port 143b is configured to receive IMAP requests from the IMAP application 322. In such a configuration, port 143a may be designated as port number 80 under a standard network protocol such as the TCP/IP protocol discussed earlier and as known in the art. Port 143b may be designated as port number 143 under the standard network protocol such as TCP/IP. However, many other configurations are possible, e.g. multiple communication paths from an application, etc.

Further, FIG. 3 shows a proxy server device 180 configured to exchange data with the client proxy device 140 over a communication link and for exchanging data with the network servers, for example as outlined with respect to the previous embodiments. Any communication between the proxy server 140 and the network servers 151, 152, and 153 may for example be realized via the local area network 360 and communication via packet switched transmission. However, any other communication type may be employed as well, including dedicated communication lines and wireless transmissions.

The proxy server device 180 may also comprise a dedicated data processing device, or may comprise an application program executed on a general purpose data processing device capable of running multiple applications.

The proxy server device 180 includes ports 183a and 183b, that may be designated to handle requests of a certain type. In the present case, for example, it is assumed that port 183a is responsible for HTTP requests and that port 183b is responsible for handling IMAP application requests. However, this is just one example, and other ports may handle requests of other types, such as FTP requests, or may be configured to handle multiple types of requests. In addition ports 183a and 183b may establish communication links with more than one device.

In one embodiment of the invention, the proxy server device 180 and the network server 151 may establish a communication link via port 183a of the proxy server network interface 183 and port 155a of the network server. The proxy server device 180 and the network server 152 may establish a plurality of communication links. One communication link between port 183a of the proxy server network interface 183 and port 156a of the network server 152, and the second between port 183b of the proxy server network interface 183 and port 156b of the network server 152. Network Server 153 may establish a communication link with proxy server device 180 via port 157a of the network server network interface 157 and port 183b of proxy server network interface 183.

In one embodiment of the invention, ports 155a, 156a, and 157a are ports responsible for handling HTTP requests, for example communicating with the browser 321 at the client data processing device 100. In this embodiment, port 156b may be designated for handling IMAP requests, by communicating with the IMAP application 322 at the client data processing device 100. Thus, ports 155a, 156a, and 157a may be connected to port 143a of the client proxy network connect module 143, and port 156b of network server network interface 156 may be connected to port 143b of the client proxy network connect module 143.

In the example shown in FIG. 3, network server 151 and 153 each only show one port for handling HTTP requests as discussed above, port 155a on network server 151 and port 157a on network server 153. However, network server 152 shows two ports, port 156a designated for handling HTTP requests, and port 156b designated for handling IMAP requests. However, network servers 151-153 may have any number of ports of various types, other than those depicted. For example, the ports at network servers 151-153 may be designated for handling data requests in protocols such as SMTP (Simple Mail Transfer Protocol), FTP, Gopher, etc. on behalf of applications programs executing on client data processing device 100.

The client proxy network connect module 143 may be responsible for establishing a data transmission link between the client proxy device 140 and the proxy server device 180 and/or selecting a network server and/or establishing the communication link between the proxy server and the selected network server. Information, e.g. network servers, services, client identities, on communication protocols, encryption methods, interfaces in the transmission path and similar may be maintained in a memory, such as mapping rules memory 141 accessible by the client proxy network connect module 143.

The client proxy network connect module 143 may contact the proxy server device 180 through a connection request in order to establish a data transmission link between the client proxy device 140 and the proxy server device 180. Thereafter a communication protocol may be negotiated, and may include use of encryption methods and similar processes. Preferably, the client proxy device 140 maintains information on the configuration of the proxy server 140 for use when sending a request to the proxy server device 180.

Communication between the client proxy device 140 and the proxy server device 180 may include transmission through a wide area network, such as a public network, i.e. Internet 104. However, the communication may also be accomplished by any other network, such as a local area network. Alternatively, a dedicated communication link, including wireless transmission, may be used. Preferably, a plurality of network connections may be maintained simultaneously between client side 350 and the local area network 360.

The client proxy network connect module further selects at least one of the network servers 151-153 based on the request received at the client proxy device 140 from the client data processing device 100. Further, the client proxy network connect module 143 may select a port at the selected network server. To facilitate a selection, the client proxy network connect module 143 may maintain information on local area network 360, in order to be able to select an appropriate network server for a request from client data processing device 100. Such information may include (1) available network servers; (2) services, identifiable through port number, available on the available network servers; and (3) identifiers of users authorized for access. This information on available network servers, services, and authorized users for local area network 360 may be maintained in a database at the client side 350 or at any other location. In one embodiment of the invention, this information may be stored in a memory 141 on client proxy device 140. In another embodiment, this information may be retrieved from the local area network 360 before serving a request or could be transferred before starting an access session.

The selection of one of the network servers and/or a port at one of the network servers may be based on a type of request received. For example, a request may be received from the IMAP application 322 at port 143b of the client proxy network connect module 143. The client proxy network connect module 143 may thus in turn select an email port on a server connected to local area network 360, for example port 156b at network server 152 for serving the request. This selection may be based on information maintained at the client proxy device 140, including information on available network servers and/or services available at the network servers. Such information may be stored, for example in mapping rules database 141.

If for example a request for an HTML document is received at port 141a of the client proxy device 140 from the browser 321, the client proxy device 140 may select a corresponding port on one of the network servers providing HTTP services. Such ports may include ports 155a, 156a, and 157a of network server network interfaces 155, 156, and 157 corresponding to network servers 151, 152, and 153 respectively.

In case a plurality of network servers is available for serving the request, the client proxy network connect module 143 on the client proxy device 140 may select one of the available network servers based on information maintained at the client proxy device 140, as discussed above. The client proxy network connect module 143 may act as a gateway or proxy for the corresponding type of request, and may then distribute the request based on further information included in the request, e.g. a URL of a particular document desired, as is well known in the art.

Further, it is possible to transmit this request to a dedicated site at the local area network 360 for analyzing the request and handling further distribution of the request to an appropriate network server, e.g. based on a URL contained in the request and/or a further identifier in the request such as a user identifier. Thus, the client proxy device 140 may only need to maintain information on one responsible network server (i.e. dedicated site) for each type of request. It is also possible that the proxy server device 180 analyzes the request and further distributes the request to an appropriate network server.

Further, the selection may be based on a network server identifier transmitted with the request, for example in case an application generating the request is configured to communicate with a predetermined network server.

The selection may also be based on an application requested or on the identity of a user. The client proxy network connect module 143 may directly analyze the request from the client data processing device 100, in order to determine an appropriate network server for handling the request. A network server could be directly specified in the request or could be derivable from the request.

For example, in case the request contains information such as a URL of a particular document or an identifier of a particular email account, the client proxy network connect module 143 could base the selection of the network server on this information.

In brief, the selection of a network server may be based on at least one of the following: (1) a type of request; (2) a network server identifier transmitted with the request; (3) a port number of a port at the client proxy device receiving the request; (4) a data type requested, and (5) an application requested.

Further, the client proxy network connect module 143 is preferably responsible for establishing communication links between the client proxy device 140 and an appropriate one of the network servers 151, 152, and 153. The communication link between the client proxy device 154 and the selected network server will be established through a data transmission link provided between the client proxy device 140 and the proxy server device 180. This may involve mapping, i.e. assigning at least one port of the client proxy device 140 to at least one port of the network servers, possibly in multiple steps. Preferably in a first operation, a port of the client proxy device 140 may be mapped to a port of the proxy server device 180. In a second operation, the port of the proxy server device 180 may be mapped to a port of the selected local server. This may include instructing the proxy server device 180 to perform the required assignment with a mapping message from the client proxy network connect module 143. The client proxy network connect module 143 may further authorize the selected network server to serve the request.

In order to establish the communication link the client proxy network connect module 143 may include a sub-connection module for mapping at least one port of at least one of the network servers 151, 152, and 153 to at least one port of the client proxy device 140. The sub-connection module may be located at the client proxy device 140 and/or at the proxy server device 180. For example, port 143a of the client proxy device may be configured to receive, e.g. HTTP requests from browser program 321, and may be mapped to port 155a of the network server 151 and/or port 156a of the network server 152, assuming that ports 155a and 156a are HTTP ports. The other ports may be mapped similarly. It is noted that this is an example only, as additional ports may be provided at the network servers, and additional network servers may be provided.

The client proxy network connect module 143 may also include a second sub-connection module for mapping at least one port of the proxy server device 180 to at least one port of the client proxy device 140.

The information on establishing the data transmission link between the client proxy device 140 and the proxy server device 180, and the information for facilitating a selection of one of the available network servers at the local area network 360, and establishing the communication link between the client proxy device 140 and the selected network server could also be stored in a memory 141 as mapping rules. These mapping rules may be retrieved by the client proxy network connect module 143 upon receiving a request at the client data processing device 100.

Thus, the client proxy network connect module 143 may be arranged to select one of the network servers and to retrieve corresponding mapping rules, for example including information on establishing a secure transmission link to the destination proxy server. This may include information on configuring the client proxy device 140 and/or the proxy server device 180 in accordance with the request received, in establishing the transmission link to the proxy server based on the transmission medium to be used, e.g. a public network, and the specific configuration of the proxy server of the local area network 360. Therefore, the rules may include information on the type of transmission link to be established to the proxy server device 180, and/or the communication type request, and/or the configuration of the client proxy device 140, and/or the configuration of the proxy server device 180 and similar.

This may be particularly important in case a plurality of proxy servers and/or a plurality of local area networks is provided and connections to different proxy servers may be requested at the client data processing device 100, e.g., in case a plurality of local area networks such as local area network 360 or in case the local area network comprises a plurality of proxy servers.

In the embodiment shown in FIG. 3, the browser 321 sends a request, e.g. an HTTP request to the client proxy device 140, which on behalf of the browser 321 handles all requests. In other words, the browser 321 will only interact with the client proxy device 140 and need not be aware of further communications between the client proxy device 140 and further components of the access system. Thus, the client data processing device 100 can interact with the network servers 151, 152, and 153 through the client proxy device 140 and will be virtually part of the local area network 360, even though it may be located remote from the local area network 360. Therefore, a virtual private network will be established including the local area network 360 and the client data processing device 100.

The mapping of the communication link may follow predetermined rules, which may, e.g. be determined by the characteristics of the local area network and the required communication link, including security aspects. The client proxy network connect module 143, working within client proxy device 140, may be part of an access unit. Thus, a user operating the client may be enabled to access the local area network 360 by sending requests from the client data processing device 100 to the client proxy device 140. This establishes a data transmission link between the client proxy device 140 and the proxy server device 180, mapping ports 143a and 143b of the client proxy device 140 to ports of the at least one network server, 155a, 156a, 156b, 157a. Once the appropriate ports have been mapped and opened, application programs e.g. browser 321 and IMAP application 322, executing on client data processing device 100 can request and retrieve data from the at least one network server 151, 152 and 153 of the local area network 360 through the proxy server device 180.

A computer readable medium may be provided, having a program recorded thereon, where the program is to make a computer or system of data processing devices execute functions of the client proxy device 140, including the client proxy network connect module 143, and/or proxy server device 180. The computer program may also be distributed between the client and the local area network, e.g. the proxy server. A computer readable medium can be a magnetic or optical or other tangible medium on which a program is recorded, but can also be a signal, e.g. analog or digital, electromagnetic or optical, in which the program is embodied for transmission.

Further, a computer program product may be provided comprising the computer readable medium.

Still further, the proxy server device 180 may be configured to allow access to only selected services, or selected network servers. Restricted access may be predetermined at the proxy server for all accesses or may depend on the mapping rules retrieved by the client proxy network connect module 143 at the client side. Access restrictions may be necessary to enhance security of a network. For example, the proxy server could be instructed to only allow certain services which are not security-sensitive.

It is noted that even though data requests in the embodiment described above emanate from the client side, any connection established may preferably be bi-directional allowing a data transmission and/or sending of requests from the network server to the data processing device 100.

Normally, a client data processing device 100, i.e. a user operating the client data processing device, will have to be authorized at the local are network 360 in order to be granted access to the network servers, i.e. to obtain the requested service. This may involve an authorization procedure including entering a user password at, e.g., the proxy server device 180. However, since a secure data transmission between the client proxy device 140 and the proxy server device 180 may be established, it is also possible that an authorization procedure for accessing the local area network 360 is performed locally at the client data processing device 100, i.e. the user enters a password for an authorization procedure at the client.

The access system of the shown embodiment provides improved access from the client data processing device 100 to information on the network servers 151, 152, and 153, even if direct access to network servers is not possible due to access restrictions at the local area network. Access may be obtained from the client data processing device 100 through the client proxy device 140 and the proxy server device 180, e.g. for requesting services from the network servers such as obtaining data files, starting applications, and similar. By providing a mapping of the appropriate ports of the client proxy device 140 to the ports of the network servers, a user at the client may have a virtual direct access to services provided at the network servers.

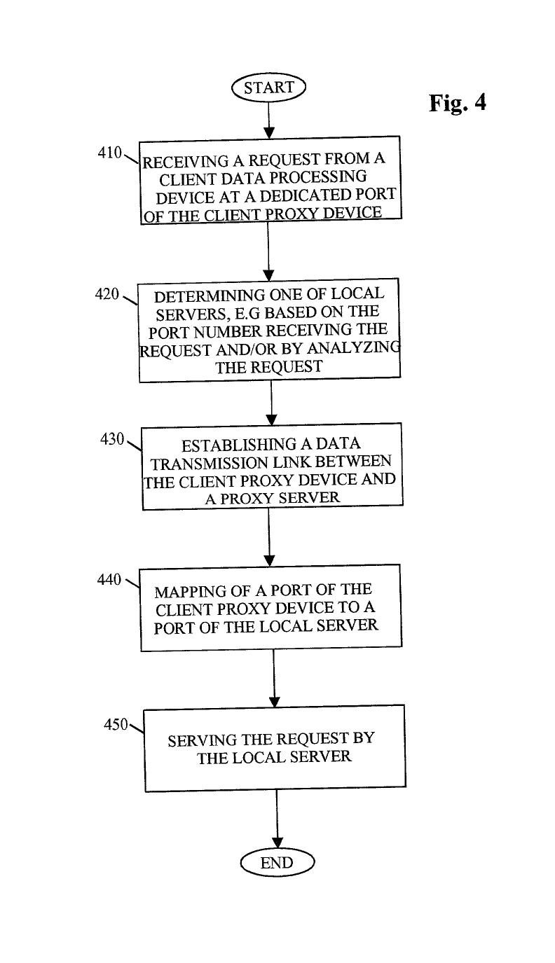

In the following, a further embodiment of the invention will be described with respect to FIG. 4. FIG. 4 shows a flow diagram illustrating operations of the method according to another embodiment of the invention.

The method according to this embodiment provides improved access to information available on network servers through use of a client proxy device 140 and a proxy server device 180 and a mapping of ports, e.g. for requesting services from the network servers such as obtaining data files, starting applications and similar.

In a first operation 410 a request from a client data processing device 100, generally through an application program, such as browser program 321 or IMAP application program 322, executing on the client data processing device, is received at a port of the client proxy device 140. For example, in one embodiment of the invention employing the TCP/IP communication protocol, an HTTP request would be received at port number 80, and an IMAP request would be received at port number 143, as outlined above. The request may include a request for data or may include instructions for execution of an application at one of the network servers or similar. The request may be transmitted from the client data processing device 100 to the client proxy device 140 by specifying the address of the client proxy device 140 and a port number corresponding to the type of the request. However, it is also possible that the request is transmitted to the client proxy device 140 via an internal connection, e.g. in case the client proxy device 140 and the client data processing device 100 are located in a single device.

Thereafter, in an operation 420 at least one appropriate network server for serving the request is determined for example by the client proxy network connect module 143. The client proxy network connect module may consult, for example mapping rule memory 141 to determine the appropriate network server based on the port number of the port receiving the request at the client proxy module 140. In this case, for example, an HTTP request would be received at port number 80 at the client proxy device 140 and therefore it is known that the request concerns an HTTP request. Since preferably information on the servers available at local area network 360 is maintained at the client proxy device 140, an appropriate one of the network servers may be determined, as outlined before.

Further, the appropriate network server may be determined by analyzing the request, e.g. a network server identifier or URL contained in the request or similar.

This may be particularly advantageous in a case where more than one network is provided at the local area network for serving a particular request type, such as HTTP requests or requests for email applications. In this case by analyzing the request, a specific one of the plurality of servers capable of serving the request could be determined.

In operation 430 a data transmission link between client proxy device 140 and a proxy server device 180 is established, for example as outlined before with respect to the embodiments of the invention described above. The transmission link may be a temporary one, only for serving the received request, or may be established for serving a plurality of requests from client data processing device 100 and/or optionally other data processing devices.

In an operation 440, a specific port of the client proxy device 140 is mapped to a port of a network server. Since in operation 420 it was already determined which network server of servers should serve the request from the client data processing device 100, and thus at least one particular port for serving the request is known, the port receiving the request at the client proxy device 140 may be mapped to a corresponding port of the selected network server. The mapping may be comprised of generating a list of port assignments, i.e. a port of the client proxy device 140, a port of the proxy server device 180, and a port of the selected network server. If it is assumed that network server 151 may act as a gateway or proxy for HTTP requests and further routes these requests to the HTTP server storing the requested data, the port 143a of the client proxy device 140 could be assigned to a port of the proxy server device 180 and to port 155a of the network server 151, if for example an HTTP request is received from browser 321 at port 143a of the client proxy device 140.

The communication link between the client proxy device 140 and the network server is preferably bi-directional and includes the data transmission link established between the client proxy device and the proxy server device 180.

The client proxy device 140 and the client proxy network connect module 143 may hold mapping rules for mapping the ports of the client proxy device 140 to ports of the network servers in data files in a memory. This information preferably includes addresses of available network servers, their ports and/or services provided.

After mapping the ports of the client proxy device 140 and the network server, a communication link between the client proxy device and the proxy server device 180 to the appropriate network server and any response from the network server would be routed through the proxy server device 180 and the client proxy device 140 to the client data processing device 100.

In an operation 450 the network server responds to the request from the client data processing device, e.g. by returning data or executing an application. It is also possible that the client data processing device is used to control the execution of an application at the network server.

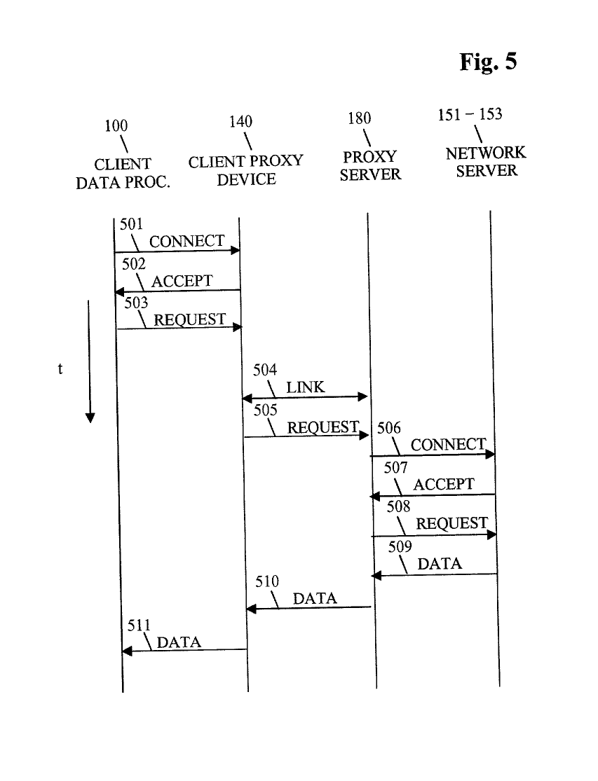

In the following, a further embodiment of the invention will be described with respect to FIG. 5. FIG. 5 shows a flow diagram of a time sequence of operations of the method according to another embodiment of the invention.

FIG. 5 illustrates a message and data flow between the client data processing device 100, the client proxy device 140, the proxy server device 180, and network servers 151-153 as an example of a network server being accessed. As indicated in FIG. 5, time t runs in a vertical downward direction.

In a first operation 501, a connection request is sent from a process executing on the client data processing device 100 to the client proxy device 140, requesting a connection. In the case of a packet switched network, this may be accomplished as known in the art by a connection request, e.g. “connect (socket channel, IP address, port number). The socket channel is a channel of the client data processing device 100, the IP address is the Internet Protocol address of the client proxy device 100, and the port specifies the requested type of service, e.g. FTP, HTTP, etc. as outlined above.

In response to the connection request, the client proxy device 140 transmits an accept message to the client data processing device 100 in an operation 502, also known in the art by transmitting a message “Accept (master channel, client channel)”. The master channel specifies the channel for any request from the client data processing device 100. The client channel specifies a particular channel, i.e. a socket for use for this particular connection. Even though not shown in FIG. 5, the establishment of a transmission connection between the client data processing device 100 and the client proxy device 140 may also include the command “Bind (channel, local end point)” specifying a channel and a local communication end point, e.g. a port and the command “Listen (channel)” specifying a channel.

After establishing the bi-directional connection between the client data processing device and the client proxy device, “read” and “send” commands may be transmitted. Accordingly, in an operation 503 the client transmits a request for data to the client proxy device 140, e.g. a request generated at a browser executed at the client side or any mail application or an ftp-application or similar. In the present case, a request may concern a document in the HTML format to be retrieved from the local area network. However, it is also possible that a message is scheduled for transmission from the client data processing device to the network server, as in the case of an email message sent by a user at the client side.

Upon receiving the request, the client proxy device 140 analyzes the request, e.g. in order to determine whether a data packet from the local area network 360 is requested. In case a data packet requested is not located in the local area network, the client proxy device 140 may, of course, directly retrieve the requested document, e.g. from a public network such as the Internet. However, in case it is determined that the requested document is to be retrieved from the local area network 360, the client proxy device 140 in this embodiment retrieves mapping rules for establishing a connection to the proxy server device 180. These rules, as outlined above, may be based on the request received, the service type requested, the characteristics of local area network 360 and the proxy server, and characteristics of the available medium between the client proxy device 140 and the proxy server device 180. Such rules may include information on a public network to be used, including security measures necessary for establishing data integrity and authenticity. The mapping rules may be retrieved either at the client side or may be retrieved from the local area network 360, e.g. a publicly accessible server of the local area network or from any other location. After retrieving the mapping rules, the client proxy device 140, in an operation 504 establishes a transmission link to the proxy server device 180, such as a tunnel connection providing data authenticity and integrity via a public network.

After establishing the transmission link in an operation 505, the client proxy device 140 sends a request to the proxy server device 180, corresponding to the request previously received from the client data processing device 100 in operation 503. Preferably, the client proxy device 140 will include as an originating address its own address or identifier, i.e. IP address, in order to receive any responses. In this case, the client proxy device 140 will save information on any received request from the client data processing device in order to be able to properly route any retrieved data documents back to the client data processing device or browser, respectively.

After receiving the request, the proxy server device 180 will analyze the request and based on the information included in the request, determine the appropriate network server storing the requested data and the appropriate port number.

Then, in an operation 506, the proxy server device 180 transmits a “connect” request to the appropriate network server, e.g. similar to the one outlined with respect to operation 501. In response thereto, the receiving network server in an operation 507 sends an “accept” message, e.g. corresponding to the accept message sent in operation 502 from the client proxy device 140 to the client data processing device 100. Upon establishing the connection between proxy server and network server, the proxy server in an operation 508 will transmit a request corresponding to the request received in operation 505 from the client proxy device 140 to the network server determined to be storing the data requested by the client data processing device 100.

The network server will transmit the requested data in an operation 509 to the proxy server 140, which will forward the data in an operation 510 to client proxy device 140. Client proxy device 140 will then forward the data in operation 511 to the client data processing device.

Accordingly, embodiments of the invention as discussed above provide a virtual private network for the client data processing device, i.e. a scenario, wherein, through provision of the client proxy device 140, the client data processing device 100 is virtually part of the local area network 360.

It is noted that the client data processing device 100 does not need to have any knowledge about the connection, particularly the transmission link between the client proxy device 140 and the proxy server device 180.

Further, according to this embodiment the client proxy device, in accordance with the retrieved rules, may only be provided with information on the transmission link, or tunnel to be established to the proxy server device 180. The proxy server device 180 may then connect to the appropriate network server 151-153 as discussed above.

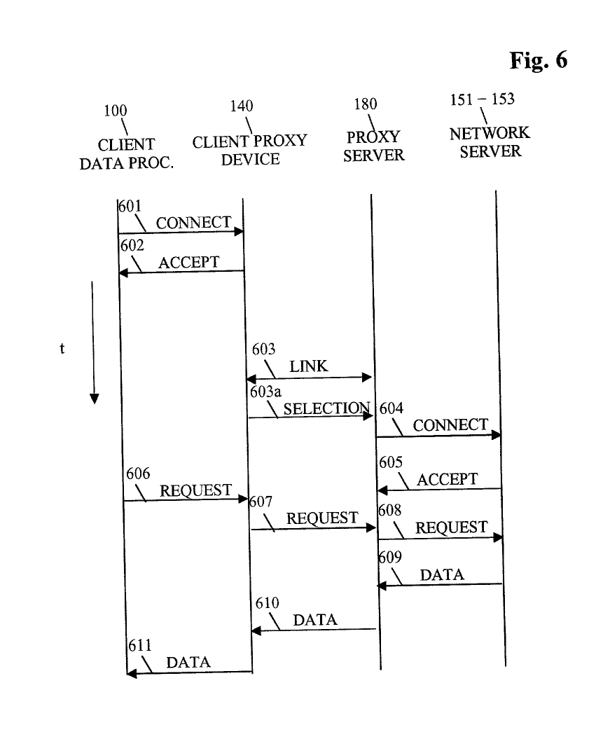

In the following, a further embodiment of the invention will be discussed with respect to FIG. 6. FIG. 6 shows a flow diagram of a time sequence of operations of the method, according to another embodiment of the invention. FIG. 6 is similar to FIG. 5, however, in the embodiment of FIG. 6, first the communication links between the elements of the system are established and thereafter the request from the client data processing device 100 is routed to the network server for execution.

In a first operation 601 a connection is transmitted from the client data processing device 100 to the client proxy device 140. In an operation 602 an accept message is returned to the client data processing device, resulting in a communication link between the client data processing device and the client proxy device.

In an operation 603 a data transmission link is established between the client proxy device and the proxy server, e.g. under control of the client proxy network connect module 143. Establishing the data transmission link may include negotiating port numbers for data transmission, transmission protocols for data transmission, including encryption and similar. Further, establishing the data transmission link between the client proxy device 140 and the proxy server device 180 may include negotiating protocols for a data transmission with further elements in the transmission path.

Preferably, a process executing at the client proxy device 140 then transmits in an operation 603a information specifying the selected network server to the proxy server, e.g. via selection message to the proxy server, in order to instruct the proxy server to connect to the selected network server.

Thereafter, in an operation 604, the proxy server transmits a connection request to the selected network server determined at the client proxy device 140.

In an operation 605 the network server responds with an accept message to the proxy server and thus a data transmission path between the client data processing device and the network server is established.

Thereafter, in operations 606, 607 and 608 the request from the client data processing device 100 is transmitted to the network server via the client proxy device 140 and the proxy server.

However, it is noted that transmission of the request from the client data processing device to the client proxy device may already be accomplished earlier in time, for example before operation 603.

Thereafter, in operation 609, 610 and 611, requested data are transmitted from the network server to the client data processing device 100. Alternatively, after operation 608 an application may be executed at the network server, for example, performing computationally expensive rendering of image data for display at the client data processing device, calculating computational results, or editing documents. The results of the application executed at the network server could be transmitted back to the client data processing device for display in operations 609, 610, and 611.

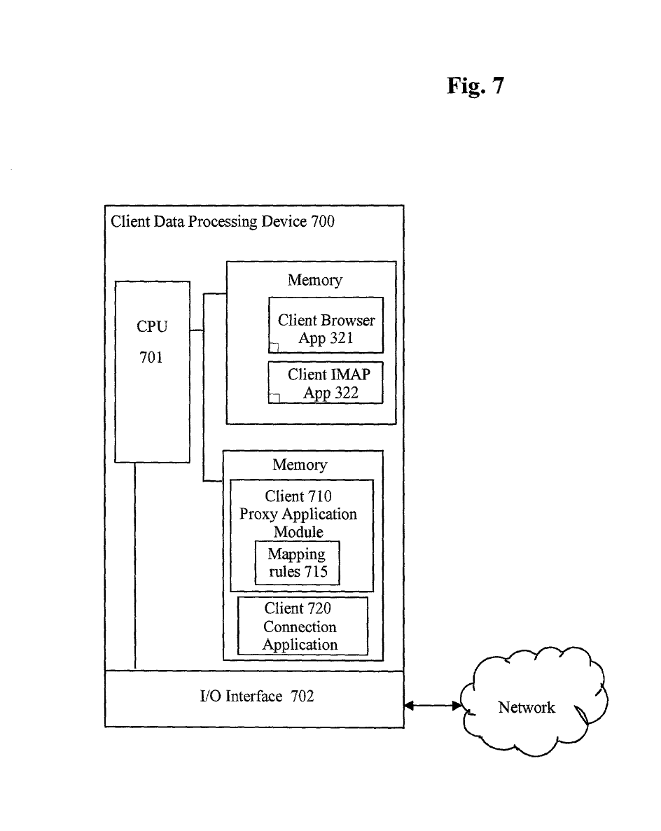

In the following, a further embodiment of the invention will be described with respect to FIG. 7. FIG. 7 shows a block diagram illustrating elements of an access system according to another embodiment of the invention particularly illustrating elements at the client side 350.

In FIG. 7, a client data processing device 700 includes a client proxy application module 710, a connection application 720, the browser 321, and the IMAP application 322.

The client proxy application module 710 may be executed at the client data processing device 100 as an application program which may be started by a user at the client data processing device planning to access the local area network 360, e.g. as outlined with respect to previous embodiments.

Further the client connection application 720 may comprise a code section containing instructions for executing the functions of the client proxy network connect module 143, e.g. as outlined with respect to previous embodiments. The client connection application 720 may be executed at the client data processing device 700 as an application program that may be started by a user at the client data processing device.

The client proxy application 710 and the connection application 720 may for example be started by clicking on an icon on a display associated with the client data processing device 700.

The applications generating requests, for example the browser 321 and the IMAP application 322, the client proxy application 710, and the connection application 720 may thus be constituted by processes running at the client data processing device 700.

Therefore, providing that requests for the local area network 360, for example from the browser 321 and the IMAP application 322, are transmitted to the client proxy application 710 is different from previous embodiments.

In the present case, the client data processing device 700 is preferably registered as a proxy at the client data processing device itself in case a proxy enabled application is executed. By registering the client data processing device as a proxy, a request from a proxy-enabled application will be routed internally in the client data processing device 700 to the client proxy application module 710 for further handling.

Further, in case an application is executed which is not proxy-enabled, e.g. a browser or IMAP application without proxy function, the name of a network server is preferably replaced by the name of the client data processing device and a specific port. By introducing the name of the client data processing device as destination for outgoing requests, requests generated at the client data processing device will be returned to the client data processing device for further handling at the client proxy application 710, i.e. requests will be internally routed to the client proxy application.

Apart from this modification, the embodiment described with respect to FIG. 7 may operate as outlined with respect to previous embodiments.

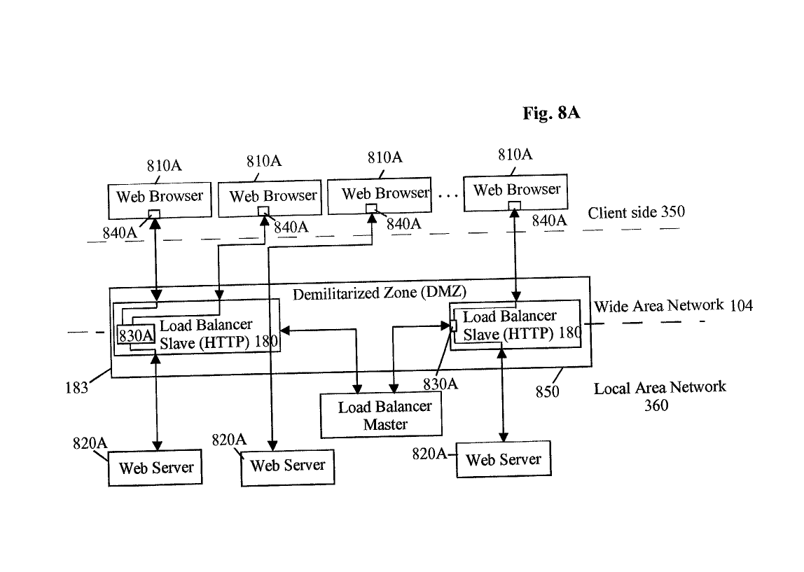

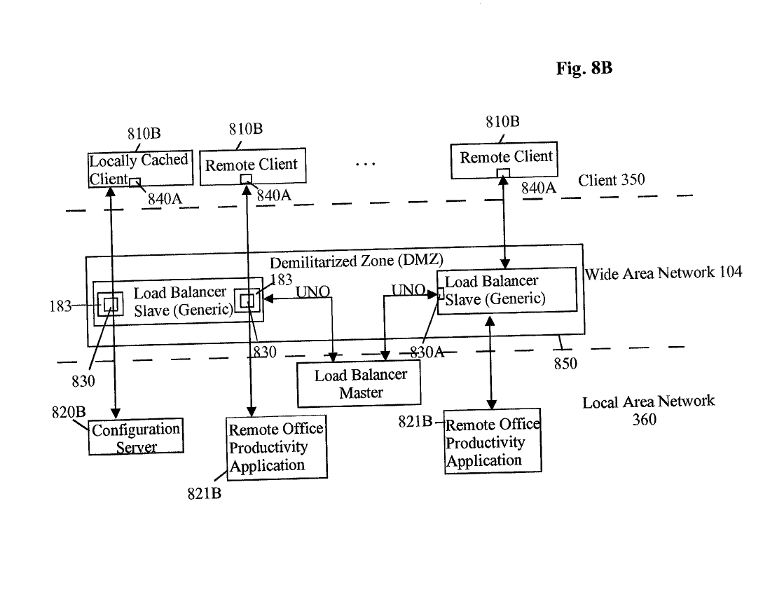

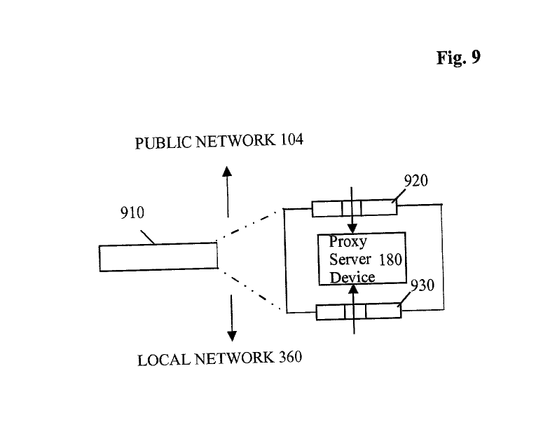

In the following other embodiments of the invention will be described with respect to FIGS. 8A and 8B. FIGS. 8A and 8B each show a block diagram of elements of an access system according to another embodiment of the invention, including accessing the local area network through a firewall 850 via a secure connection. In one embodiment of the invention, the firewall may be arranged between the local area network 360 containing the network servers and the proxy server device 180, and the wide area network 104 connecting the client data processing device 100. However, in the embodiments described with respect to FIGS. 8A, 8B, and 9, the proxy server or plurality of proxy servers 180 may be arranged within firewall 850. Also, with respect to the embodiments set forth in FIGS. 8A and 8B, a load balancing system and method as set forth in U.S. patent application Ser. No. ______, filed ______, and incorporated herein by reference, may be employed as part of firewall 850 and proxy server device 180.

FIG. 8A illustrates a plurality of client data processing devices 810A, wherein each client data processing device may execute applications, such as web browser programs, that may issue data requests to, e.g. one or more web server data processing devices 820A on local area network 360. Further, FIG. 8A shows proxy server security module 830 and client proxy security module 840AA for establishing a secure data transmission via a transmission link established through Internet 104 as described above, between client proxy device 140 and proxy server device 180.

FIG. 8B depicts a similar configuration as that illustrated in FIG. 8A. However, the plurality of client data processing devices 810B in FIG. 8B are shown executing various client application programs to transmit commands to and display the results of application programs executed remotely on network servers, such as 820B and 821B, connected to local area network 360. Client data processing device 810B may execute client programs, such as browser programs, to transmit data to and display results from, e.g. an office productivity application executing remotely on network server 821B. Alternatively, client data processing device 810B may execute local application programs such as an office productivity application program. In this scenario, client data processing device 810B may utilize a client program to receive and transmit stored data, such as configuration data from configuration server 820B, to set parameters for execution of local application programs on client data processing device 810B.

The proxy server device 180 and proxy server security module 830, along with proxy server network connect module 183 are arranged at the local area network side 360. The client proxy device 140 and client proxy security module 840A, along with client proxy network connect module 183, are arranged at the client side 350. The communication link passes e.g. a wide area network, such as Internet 104, as described above. Further, FIG. 8A shows a firewall arrangement 850 restricting access to the local area network 360 from the public wide area network 104.

The proxy server security module 830 and client proxy security module 840A may provide data encryption techniques for assuring data confidentiality and integrity. Standard security functions may be used; however, security functions adapted to the characteristics of the client proxy device 140 and/or the proxy server device 180 are employed. The proxy server security module 830 and client proxy security module 840A may comprise dedicated devices, e.g. realized in hardware or comprising a code section containing instructions for data encryption for providing data confidentiality and data integrity.

Further, the firewall arrangement 850 restricts access to the local area network 360 from the public network 104. A firewall is generally a method for keeping a network secure. It can, for example, be implemented in a router that filters out unwanted packets, or it may use a combination of technologies known in the art in routers and hosts. Firewalls may be used to give users access to public networks in a secure fashion as well as to separate a company's public Web server from its internal network. They may also be used to keep internal network segments secure. A firewall, as known in the art, may be a packet filter allowing passing of only selected packets, e.g. packets with a specific IP address and/or a specific port number. Further, firewalls may perform certain processing operations on any packet received from the outside (or inside), before it is transmitted to the local area network 360 side (or to the outside).

Since access to the local area network side is only allowed through the firewall, communication links between a client and a network server, as known in the art cannot be established. However, the client proxy device 140 and the proxy server device 180 may negotiate a communication protocol involving the firewall 850. The data transmission link between the client proxy device 140 and the network servers may pass the firewall 850. The client proxy security module 840A and the proxy server security module 830 preferably provide the necessary tools for connecting and communicating with the firewall. This may involve operations for contacting the firewall and establishing a communication therewith, and instructing the firewall to forward information.

The security tools provided for the client proxy security module 840A and the proxy server security module 830 may be controlled, respectively, by client proxy network connect module 143 and proxy server network interface 183. Client proxy security module 840A and proxy server security module 830 may each further comprise stored mapping rules, mapping a port of the client proxy device 140 to the firewall 830 and a port of the firewall to the proxy server device 180. Accordingly, packets may be properly transmitted through the firewall from the client proxy device 140 to the proxy server device 180 and vice versa.

In the following a further embodiment of the invention is described with respect to FIG. 9. FIG. 9 shows a block diagram illustrating elements of an access system according to an embodiment of the invention, particularly illustrating a firewall.

FIG. 9 shows a firewall 910 and an enlarged view thereof including a first packet filter 920 and a second packet filter 930.

As shown in FIG. 9, the proxy server device 180 is arranged between the packet filters 920 and 930. The proxy server device 180 may be accessed, e.g. only via packets provided with a specific address of the proxy server, such as the proxy server's IP address, as well as a specific port number. Since the proxy server device 180 is arranged between the two packet filters of the firewall 910, enhanced security may be achieved since the proxy server device 180 is access restricted from within the local area network 360 and from the public network 104.

As in FIGS. 8A and 8B, in FIG. 9 the proxy server device 180 is thus arranged in the so-called demilitarized zone (DMZ) of the firewall and will receive requests from the client through the packet filter 920 and will connect to the network servers 151, 152, and 153 through the second packet filter 930 for retrieving data. In the demilitarized zone of a firewall, further components of the network may be located, for example a publicly accessible World Wide Web (WWW) server, or other components.

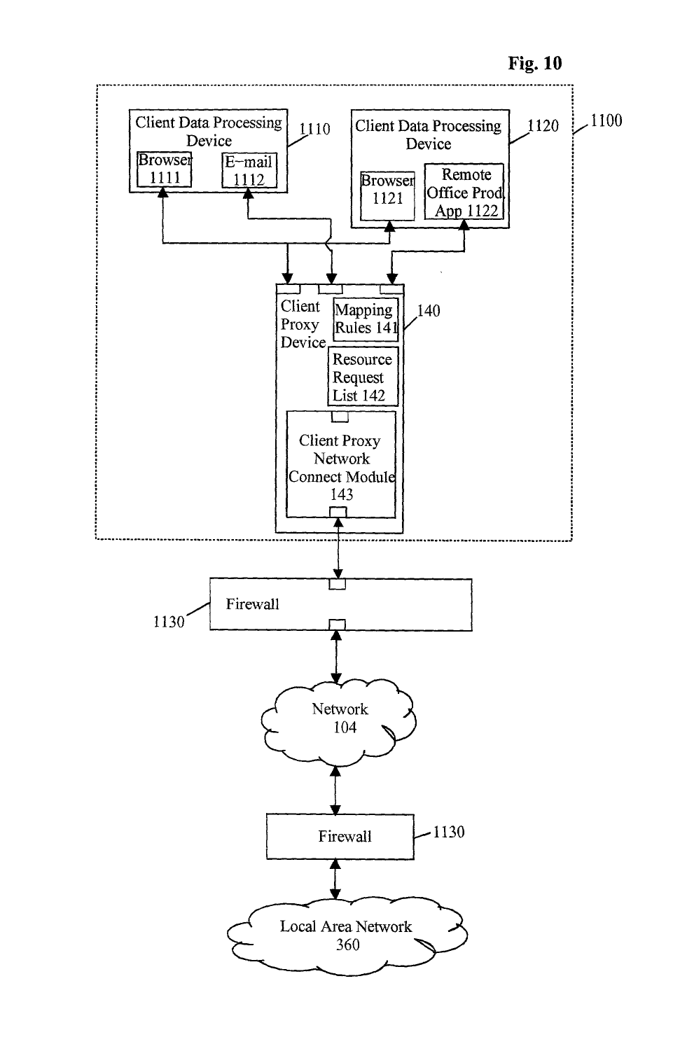

In the following a further embodiment of the invention will be described with respect to FIG. 10. FIG. 10 shows elements of the access system according to another embodiment of the invention, particularly illustrating elements at the client side.

FIG. 10 illustrates a client network 1100 indicated by a dashed line. The client network may be connected to the local area network 360 through the client proxy network connect module 143, as outlined with respect to previous embodiments.

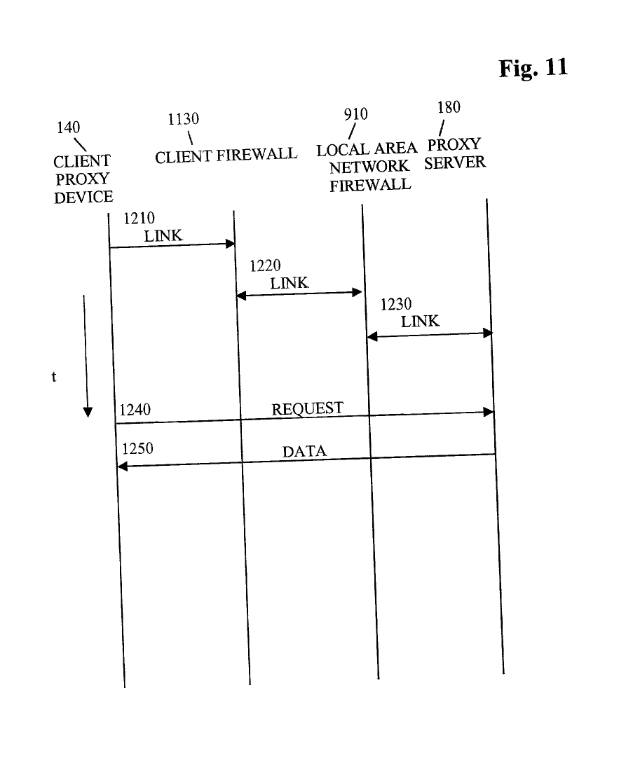

Inside the client network 1100, the client proxy device 140 and the client proxy network connect module 143 are arranged and may operate as for example described with respect to previous embodiments. According to FIG. 11, a plurality of client data processing devices may be provided, of which a client data processing device 1110 and a client data processing device 1120 are illustrated as examples, although other network configurations may be contemplated. Each client data processing device may run application programs that generate requests for service, as outlined before. In FIG. 10, a first client data processing device 1110 runs applications such as browser program 1111 and email application 1112, and a second client data processing device 1120 executes applications such as browser program 1121 and remote office productivity application 1122. Of course, one or more of these or other applications may be executed on each client data processing device, as outlined with respect to previously described embodiments. The client data processing devices 1110 and 1120 are each connected to a client proxy device 140, as outlined before.

The access system according to the shown embodiment may thus connect the client network 1100 and the local area network 360 through client proxy network connect module 143. Accordingly, a virtual private network involving the local area network 360 and the client network 1100 may be established via client proxy device 140 and proxy server device 180.

Further, FIG. 10 shows a second firewall 1130 restricting access to the client network 1100, for example from a publicly accessible packet switched network, e.g. Internet 104. Therefore, both networks may be provided with a firewall for restricting access from the outside and the client proxy device 140 and client proxy network connect module 143 need to be provided with appropriate tools for passing both firewalls. This may be accomplished, e.g., by connecting to the client network firewall 1130 to connect to the local area network firewall, and instructing same to contact the proxy server device 180 at the local area network 360. The tools for passing the firewall, i.e. for mapping the ports between the client proxy device 140 and the proxy server device 180 may be implemented in software and may be retrieved with the mapping rules, as outlined above.

In the following, a further embodiment of the invention will be described with respect to FIG. 11. FIG. 11 shows a flow diagram of a time sequence of operations preformed in the method according to an embodiment of the invention, in case a firewall restricts access to the local area networks.

FIG. 11 shows messages and data exchanged between the client proxy device 140, the client firewall 1130, the local area network firewall 910 and the proxy server device 180. Time is denoted in the downward vertical direction.

It is assumed that the client proxy device 140 received a request from the client data processing device 100.

In order to serve the request, in a first operation 1210 the client proxy device 140 may establish a data transmission link to the firewall 1130 at the client side. A communication protocol, such as HTTP-S (Secure Hypertext Transfer Protocol) or SSL (Secure Sockets Layer) may be negotiated, depending on characteristics of the firewall and of the client proxy device 140.

In an operation 1220, the client proxy device 140 may instruct the client firewall 1130 to contact the firewall of the local area network in order to establish a data transmission link between the client firewall 1130 and the local area network firewall. A communication protocol depending on the characteristics of the client firewall and the local area network firewall may be negotiated.

In an operation 1230, the client proxy device 140 may instruct the firewall of the local area network to contact the proxy server device 180 in order to establish a data transmission link there between.

The process of establishing the data transmission links in operation 1210, 1220, and 1230 may depend on mapping rules retrieved from a memory at the client proxy device 140. However, it is also possible that information is available e.g. at the client firewall to contact the local area network firewall and at the local area network firewall to contact the proxy server.

After establishing the link in the three operations between the client proxy device 140 and the proxy server device 180, in an operation 1240 a communication between the client proxy device 140 and a selected network server may be established. Then the request received from the client data processing device 100 is forwarded to the proxy server device 180. The proxy server may be instructed by the client proxy device or may analyze the request to contact the appropriate network server for retrieving the requested data. After receiving the data, the proxy server device 180 may transmit in an operation 1250 the data to the client proxy device 140, which will then forward the data to the client data processing device 140 for further processing, visualization, or similar.

Thus, embodiments of the invention, as described above, permit the configuration of a virtual private network, e.g. through a publicly accessible network to a client data processing device or a client local area network comprising a plurality of client data processing devices. The communication link between the client proxy device 140 and the proxy server device 180, when configured and employed as described in the above embodiments, may provide for secure transmission of data, preserving authenticity and integrity of data. In this way, embodiments of the invention may be utilized for the execution of security sensitive applications across a publicly accessible computer network.

Although particular embodiments of the invention have been described, it will be appreciated that many modifications/additions and/or substitutions may be made within the scope of the invention.

What is claimed is:

1. A system for enabling a user to access a local area network from a remotely located host in a computer network, comprising:
a client proxy device adapted to receive a request of a client data processing device to access at least one network server; and
a network connect module coupled to said client proxy device, wherein the network connect module, in response to said request, establishes a communication link including a data transmission link between the client proxy device and a proxy server coupled to the at least one network server.

2. The system of claim 1, further comprising a network server selector coupled to the client proxy device wherein the network server is selected using information included in the request from the client data processing device.

3. The system of claim 1, further comprising a network server selector coupled to the client proxy device wherein the network server is selected using information of a port at the client proxy device that received the request.

4. The system of claim 1, wherein
the communication link between the client proxy device and the at least one network server includes at least one port of the client proxy device and at least one port of the at least one network server.

5. The system of claim 1, wherein
the network connect module is arranged to generate a list of assignments between at least one port of the client proxy device and at least one port of the at least one network server.

6. The system of claim 1, wherein the network connect module is arranged for retrieving mapping rules corresponding to the client proxy device and the proxy server, wherein the mapping rules include information on establishing the data transmission link between the client proxy device and the proxy server.

7. The system of claim 6, wherein the mapping rules further include address information of the at least one network server in the local area network.

8. The system of claim 6, wherein the network connect module comprises
a first sub-connection module including sub-mapping rules having connection information of at least one port of the client proxy device to at least one port of the proxy server; and
a second sub-connection module including sub-mapping rules having connection information of at least one port of the proxy server to at least one port of the at least one network server.

9. The system of claim 1, wherein the data transmission link between the proxy server and the client proxy device involves a secure communication via a public network.

10. The system of claim 1, wherein the request of the client data processing device to access at least one network server is authorized prior to establishing the communication link.

11. The system of claim 1, wherein the data transmission link between the client proxy device and the proxy server is established through a firewall restricting access to the local area network.

12. The system of claim 11, wherein the connection link further comprises
a first mapping module including mapping rules having connection information of a port of the client proxy device to a port of the firewall; and
a second mapping module including mapping rules having connection information of a port of the firewall to a port of the proxy server.

13. The system of claim 1, wherein the client data processing device is part of a client network and the data transmission link between the client proxy device and the proxy server is further established through a firewall restricting access to client network.

14. The system of claim 1, wherein the proxy server is located inside a firewall restricting access to the local area network from the outside.

15. The system of claim 1, wherein the proxy server is configured to allow access only to pre-selected network servers and services.

16. The system of claim 1, wherein the client data processing device further comprises a registration module containing designation information wherein the client proxy device is designated as a proxy enabling execution of an application that is proxy enabled.

17. The system of claim 1, further comprising a replacement module containing replacement information used when executing an application that is not proxy enabled, wherein the name of a network server is replaced by the name of the client proxy device and a specified port associated with the client proxy device.

18. A method for enabling a user to access a local area network from a remotely located host in a computer network, comprising:
receiving at a client proxy device a data request from a client data processing device for data accessible from at least one network server;
establishing a data transmission link between the client proxy device and a proxy server connected to the at least one network;
establishing a communication link between the client proxy device and the at least one network server, wherein the communication link includes the data transmission link; and
authorizing at least one network server to serve the data request of the client data processing device.

19. The method of claim 18, wherein the at least one network server serving the data request is selected based on a port of the client proxy device receiving the data request.

20. The method of claim 18, wherein the at least one network server serving the data request is selected based on information included in the request.

21. The method of claim 18, wherein establishing the communication link between the client proxy device and the at least one network server includes a mapping of at least one port of the client proxy device to at least one port of the at least one network server.

22. The method of claim 21, wherein the mapping includes generating a list of assignments between the at least one port of the client proxy device and the at least one port of the at least one network server.

23. The method of claim 22 further including retrieving a set of mapping rules, wherein the mapping rules include information on establishing the data transmission link.

24. The method of claim 23, wherein the mapping rules further include address information of the at least one network server in the local area network.

25. The method of claim 23, further including
mapping at least one port of the client proxy device to at least one port of the proxy server; and
mapping the at least one port of the proxy server to at least one port of the at least one network server
wherein the mapping is executed in accordance with the retrieved mapping rules.

26. The method of claim 18, wherein the transmission between the proxy server and the client proxy device involves a secure communication via a public computer network.

27. The method of claim 18, wherein an authorization procedure to access the local area network is performed at the client data processing device.

28. The method of claim 18, wherein the data transmission link between the client proxy device and the proxy server is established through a firewall restricting access to the local area network.

29. The method of claim 28, further including mapping a port of the client proxy device to a port of the firewall and mapping the port of the firewall to a port of the proxy server.

30. The method of claim 18, wherein the client data processing device is part of a client network and the data transmission link between the client proxy device and the proxy server is further established through a firewall restricting access to the client network.

31. The method of claim 18, wherein the proxy server is located inside a firewall restricting access to the local area network.

32. The method of claim 18, wherein the proxy server is configured to allow access only to selected network servers.

33. The method of claim 18, further comprising registering the client proxy device as a proxy at the client data processing device for executing an application that is proxy enabled.

34. The method of claim 18, further comprising replacing at the client data processing device the name of the at least one network server by the name of the client proxy device and a specific port of executing an application that is not proxy enabled.

35. A computer program product having stored thereon a method for enabling a user to access a local area network from a remotely located host in a computer network, the method comprising:
receiving at a client proxy device a data request from a client data processing device for data accessible from at least one network server in the local area network;
establishing a data transmission link between the client proxy device and a proxy server connected to the at least one network server in the local area network;
establishing a communication link between the client proxy device and the at least one network server, wherein the communication link includes the data transmission link; and
authorizing at least one network server to serve the data request of the client data processing device.

36. A computer system comprising:
a processor; and
a memory storing a method for enabling a user to access a local area network from a client device in a publicly accessible computer network and not directly connected to the local area network, wherein upon execution of said method on said processor said method comprises:
receiving at a client proxy device a data request from a client data processing device for data accessible from at least one network server in the local area network;
establishing a data transmission link between the client proxy device and a proxy server connected to the at least one network server in the local area network;
establishing a communication link between the client proxy device and the at least one network server, wherein the communication link includes the data transmission link; and
authorizing at least one network server to serve the data request of the client data processing device.

37. The system of claim 36, wherein the at least one network server serving the data request is selected based on a port of the client proxy device receiving the data request.

38. The system of claim 36, wherein the at least one network server serving the data request is selected based on information included in the request.

39. The system of claim 36, wherein establishing the communication link between the client proxy device and the at least one network server includes a mapping of at least one port of the client proxy device to at least one port of the at least one network server.

40. The system of claim 39, wherein the mapping includes generating a list of assignments between the at least one port of the client proxy device and the at least one port of the at least one network server.

41. The system of claim 40 further including retrieving a set of mapping rules, wherein the mapping rules include information on establishing the data transmission link.

42. The system of claim 41, wherein the mapping rules further include address information of the at least one network server in the local area network.

43.The system of claim 41, further including
mapping at least one port of the client proxy device to at least one port of the proxy server; and
mapping the at least one port of the proxy server to at least one port of the at least one network server
wherein the mapping is executed in accordance with the retrieved mapping rules.

44. The system of claim 36, wherein the transmission between the proxy server and the client proxy device involves a secure communication via a public computer network.

45. The system of claim 36, wherein the request of the client data processing device to access at least one network server is authorized prior to establishing the communication link.

46. The system of claim 36, wherein the data transmission link between the client proxy device and the proxy server is established through a firewall restricting access to the local area network.

47. The system of claim 46, further including mapping a port of the client proxy device to a port of the firewall and mapping the port of the firewall to a port of the proxy server.

48. The system of claim 36, wherein the client data processing device is part of a client network and the data transmission link between the client proxy device and the proxy server is further established through a firewall restricting access to the client network.

49. The system of claim 36, wherein the proxy server is located inside a firewall restricting access to the local area network.

50. The system of claim 36, wherein the proxy server is configured to allow access only to selected network servers.

51. The system of claim 36, wherein the method further comprises registering the client proxy device as a proxy at the client data processing device for executing an application that is proxy enabled.

52. The method of claim 36, wherein the method further comprises replacing at the client data processing device the name of the at least one network server by the name of the client proxy device and a specific port of executing an application that is not proxy enabled.

53. A system for enabling a user to access a local area network from a remotely located host in a computer network, comprising:
a client proxy device coupled to and adapted to exchange data with a client data processing device upon a request of the client data processing device to access at least one network server in the local area network; and
a connection module for establishing a communication link between the client proxy device and the at least one network server upon the request of the client data processing device, wherein the communication link includes a data transmission link between the client proxy device and a proxy server device coupled to the at least one network server, and the connection module selects at least one network server in the local area network based on the request.
